(19) United States
(12) Patent Application Publication
(10) Pub. No.: US 2021/0214184 A1
(43) Pub. Date: Jul. 15, 2021

(54) Elevator Access Control System

(71) Applicant: Otis Elevator Company, Farmington, CT (US)

(72) Inventors: Peter Wolstenholme, Saffron Walden (GB); Dorje Soley, Kingston (GB)

(21) Appl. No.: 15/999,799

(22) PCT Filed: Feb. 18, 2016
(86) PCT No.: PCT/EP2016/053455

§ 371 Date: Aug. 20, 2018

(51) Int. Cl. B66B 1/46; B66B 11/02; B66B 1/28; H04N 7/18; H04N 5/247; G06K 9/00; G07C 9/25

(52) U.S. Cl. CPC B66B 1/468; B66B 11/0233; B66B 1/28; H04N 7/181; H04N 5/247; B66B 2201/4623; G06K 9/00255; G06K 9/00288; G07C 9/257; B66B 2201/4676; G06K 9/00778

(57) ABSTRACT

An elevator access control system comprises at least two cameras (14, 16) including: a first camera (14) which is configured to be mounted to an elevator car (6) for capturing at least one first picture of persons residing within the elevator car (6), and a second camera (16) which is configured to be mounted to the elevator car (6) for capturing at least one second picture of persons residing within the elevator car (6). The at least one first picture allows to identify individual persons, and the at least one second picture allows to count the number of persons residing within the elevator car (6).

The present application relates to an elevator access control system, an elevator car and an elevator system comprising such an elevator access control system. The application further relates to a method of controlling access to an elevator system.

Access control and security systems including mechanical barriers, which are installed in the entrance area of a building for allowing access to the building only to authorized persons, are known in the art. Authorized persons may identify themselves by means of computer readable ID-tags or ID-cards and/or by biometric features.

It would be desirable to improve the access control of persons using an elevator system for traveling to destinations within a building.

According to an exemplary embodiment of the invention, an elevator access control system comprises at least two cameras including: a first camera which is configured to be mounted to an elevator car for capturing at least one first picture of persons residing within the elevator car, and a second camera which is configured to be mounted to an elevator car for capturing at least one second picture of persons residing within the elevator car. The at least one first picture allows to identify individual persons and the at least one second picture allows to count the number of persons residing within the elevator car.

Exemplary embodiments of the invention further include a method of controlling access to an elevator system comprising at least one elevator car which is equipped with an elevator access control system, wherein the method comprises the steps of: using a first camera for capturing at least one first picture of persons residing within the elevator car; identifying individual persons from the at least one first picture captured by the first camera; using a second camera for capturing at least one second picture of persons residing within the elevator car; counting the number of persons residing within the elevator car from the at least one second picture captured by the second camera; comparing the number of persons identified from the at least one first picture to the number of persons counted from the at least one second picture; and allowing the elevator car to move only in case the number of persons identified from the at least one first picture is equal to the number of persons counted in the at least one second picture.

The combination of the at least two cameras allows to check whether all persons residing within the elevator car have been identified as being allowed to enter the at least one destination served by the elevator. It further allows to prevent any further movement of the elevator car as long as not all persons residing within the elevator car have been identified.

This configuration provides reliable access control to destinations served by an elevator system within a building without the need for placing mechanical barriers in the lobby of the building. In an elevator system according to the invention, an unauthorized person may enter the elevator car, but an elevator car including at least one unauthorized person will not depart, and in consequence the unauthorized person will not be able to move to other floors of the building. In particular, movement of the car will be prevented in cases in which non-identified users enter the car together with or shortly after an authorized user, which is identified. In consequence, there is no need to provide mechanical barriers for preventing unauthorized persons from accessing the elevators.

As a result, the access control of persons entering a building is facilitated and improved.

An exemplary embodiment of the invention is described in the following with reference to the enclosed figures.

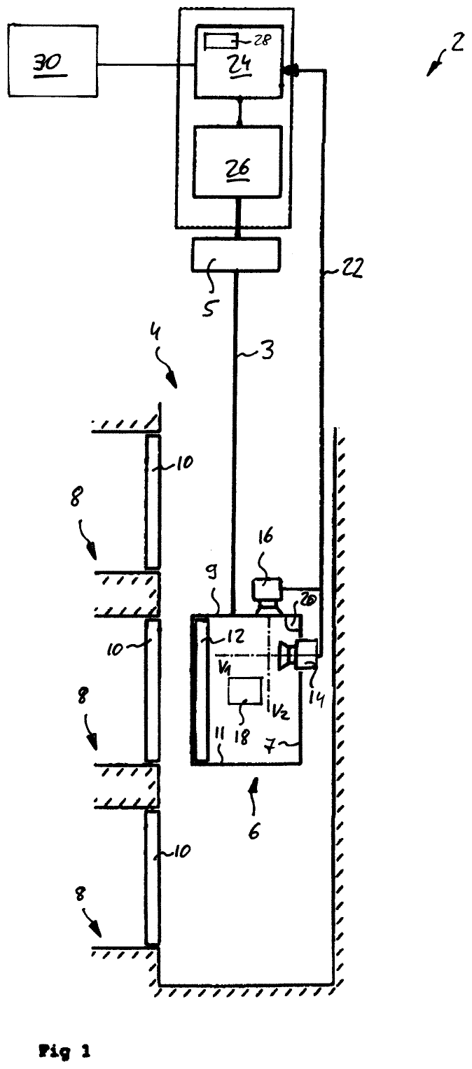

FIG. 1 depicts an elevator system comprising an elevator access control system according to an exemplary embodiment of the invention.

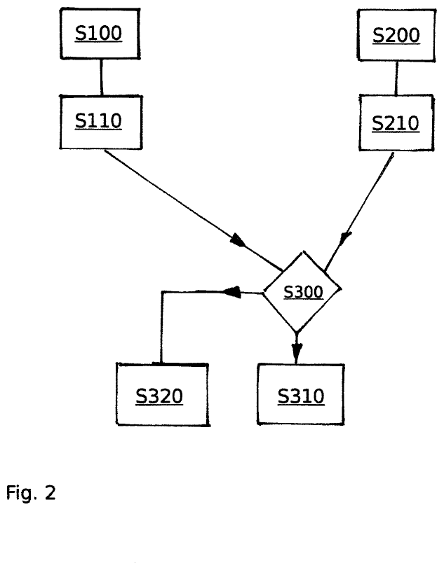

FIG. 2 is a flow diagram illustrating a method of controlling access to an elevator system according to an exemplary embodiment of the invention.

FIG. 1 depicts an elevator system 2 comprising an elevator access control system according to an exemplary embodiment of the invention.

The elevator system 2 includes an elevator car 6 which is movably suspended within a hoistway 4 by means of a tension member 3. The tension member 3, for example a rope or belt, is connected to an elevator drive 5, which is configured for driving the tension member 3 in order to move the elevator car 6 along the height of the hoistway 4 between a plurality of different landings 8.

Each landing 8 is provided with a hoistway door 10, and the elevator car 6 is provided with a corresponding elevator car door 12 allowing persons to transfer between the landing 8 and the interior of the elevator car 6 when the elevator car 6 is positioned at the respective landing 8.

The exemplary embodiment shown in FIG. 1 uses a 1:1 roping for suspending the elevator car 6. The skilled person, however, easily understands that the type of the roping is not essential for the invention and that different kinds of roping, e.g. a 2:1 roping, may be used as well. The elevator system 2 may use a counterweight (not shown) or not. The elevator drive 5 may be any form of drive used in the art, e.g. a traction drive or a hydraulic drive.

The elevator drive 5 is controlled by an elevator control unit 26 for moving the elevator car 6 between the different landings 8.

The elevator car 6 is provided with two cameras 14, 16. A first camera 14 is arranged at a rear wall 7 of the elevator car 6 opposite to the elevator car door 12 facing the elevator car door 12. The first camera 14 is configured for capturing pictures of persons entering into the elevator car 6 via the elevator car door 12. The viewing direction V₁ of the first camera 14 is oriented basically horizontally.

The viewing direction V₁ of the first camera 14, however, does not need to be oriented exactly horizontally. It is only important that the first camera 14 has a good view into the faces of persons entering the elevator car 6 through the car door 12. Thus, depending on the vertical position of the first camera 14, the viewing direction V₁ of the first camera 14 may be inclined upwards or downwards to some extent. The field of view of the first camera 14 may be relatively narrow focused to the faces of persons entering the elevator car 6 through the car door 12.

The elevator car 6 is further equipped with a second camera 16 provided at the top of the elevator car 6, e.g. at the ceiling 9 of the elevator car 6, with the viewing direction V₂ oriented downwardly. In the exemplary embodiment shown in FIG. 1, the viewing direction V₂ is oriented vertically. It is, however, also possible that the viewing direction V₂ of the second camera 16 is oriented in an acute angle with respect to the vertical. The second camera 16 should have a field of view covering the whole area of the floor 11 of the elevator car 6. Alternatively, a plurality of second cameras 16 may be provided, which, in combination, cover the whole area of the floor 11 of the elevator car 6.

An optional lighting device 20 is provided within the elevator car 6 for illuminating the persons entering into the elevator car 6, in particular the faces of said persons, in order to improve the quality of the pictures taken by the first and second cameras 14, 16.

The first and second cameras 14, 16 may take pictures in the visible range of light. Alternatively, the first and second cameras 14, 16 may operate in the infrared range. The frequency of the light emitted by the lighting device 20 is adapted to the operating range of the first and second cameras 14, 16.

The first and second cameras 14, 16 are connected by a signal line 22 or by a wireless connection (not shown) with an evaluation unit 24. The evaluation unit 24 is configured for evaluating the pictures provided by the cameras 14, 16 and for supplying a signal indicating the result of said evaluation to the elevator control unit 26.

The operation of the elevator access control system according to an exemplary embodiment of the invention is described in the following with reference to FIG. 2:

A (front) picture of every person entering the elevator car 6 through the elevator car door 12 is captured by the first camera 14, which is arranged at the opposing rear wall 7 of the elevator car 6 (S100).

Said picture is delivered to the evaluation unit 24, which is configured for evaluating the pictures (first pictures) provided by the first camera 14 in order to identify the person which has entered the elevator car 6 through the elevator car door 12 (S110).

This in particular may include to scan a database 28 comprising facial data of all persons authorized to use the elevator system 2. The first camera 14 may convert the data of the captured pictures using the Wiegand code and send a Wiegand tag to the evaluation unit 24.

Persons which are not known to the database 28 but which are authorized to use the elevator system, e.g. on a temporary basis, may be allowed to present an optical code, e.g. a QR-code, to the first camera 14 for authorization.

Simultaneously, the second camera 16 arranged at the top of the elevator car 6 takes second pictures of the interior space of the elevator car 6, preferably pictures covering the whole interior space of the elevator car 6 (S200).

These pictures are delivered to the evaluation unit 24 as well, and the evaluation unit 24 is configured for evaluating these second pictures for determining the total number of persons currently residing within the elevator car 6 (S210).

The evaluation unit 24 will compare the number of persons identified from the at least one first picture to the number of persons counted from the at least one second picture (S300) and allow the elevator control unit 26 to move the elevator car 6, i.e. to depart from the current landing 8, only in case all persons residing within the elevator car 6 have been identified as being authorized to use the elevator system 2 (S310).

In other words, the number of persons identified from the first pictures taken by the first camera 14 must be equal to the number of persons counted from the second picture(s) taken by the second camera 16 and all persons identified from the first pictures must be authorized to use the elevator system 2.

In particular, the number of persons residing within the elevator car 6, which has been determined from the second pictures provided by the second camera 16, may not exceed the number of persons which have been identified from the first pictures taken by the first camera 14 and which have been determined as being allowed to use the elevator system 2.

In case not all persons residing within the elevator car 6 have been identified as being authorized to use the elevator system 2, operation of the elevator drive 5 is blocked and an optical and/or an acoustical signal indicating that unauthorized persons are present within the elevator car 6 is generated and delivered to the persons within the elevator car 6 and/or to responsible security personal (S320).

In such a case all persons within the elevator car 6 may be requested to leave the elevator car 6 in order to start over again from an empty elevator car 6.

In an alternative embodiment the elevator access control system may be configured for tracking all persons entering the elevator car 6 in the second picture(s) allowing to distinguish between authorized and unauthorized person(s) within the second picture(s). In such an embodiment the elevator car 6 may be allowed to move as soon as all unauthorized persons have left the elevator car 6.

As an optional feature the elevator control 26 may be configured to move the elevator car 6 only to landings 8 which at least one of the persons residing within the elevator car 6 is allowed to enter. For this purpose a list of allowed landings may be associated with each potential passenger within the database 28.

The elevator access control system in particular may be configured for tracking all persons entering the elevator car 6 in the second picture(s) and associating a list of allowed landings with every tracked person which has been identified. The elevator access control system may further be configured for issuing an alarm signal in case a tracked person leaves the elevator car 6 at a landing 8 he/she is not allowed to enter.

In case a person is identified as being allowed to enter only one of the landings 8, this landing may be delivered as desired destination to the elevator control unit 26. In this case there is no need for such a person to enter his desired destination by means of a manual service call.

In the exemplary embodiment shown in FIG. 1 only a single first camera 14 and a single second camera 16 are provided, respectively. The skilled person, however, will easily understand that two or more first and/or second cameras 14, 16 may be provided. Each of such a plurality of first and/or second cameras 14, 16 may take pictures of a portion within the elevator car 6 and a combination of all pictures taken by the plurality of all cameras 14, 16 may be evaluated by the evaluation unit 24 in order to identify all persons entering the elevator car 6 and/or for reliably determining the number of persons residing within the elevator car 6.

At least one of the cameras 14, 16 may be a 3D-camera configured for taking three dimensional pictures, and each of the cameras 14, 16 may be a b/w-camera 14, 16 or a camera 14, 16 providing colored pictures.

The elevator car 6 may be equipped with a display and control unit 18 which allows to enter elevator service calls in particular elevator service calls including the desired destination(s).

Alternatively or additionally the display and control unit 18 may show the pictures taken by at least one of the cameras 14, 16 together with an indicator whether the person shown has been identified. This allows persons, which have not yet been identified, to change the position of their face with respect to the first camera 14 in order to enhance the chance of being identified.

In case the operation of the elevator drive 5 is blocked, since not all persons residing within the elevator car 6 have been identified as being allowed to use the elevator system 2, the picture(s) of the person(s) which have not been identified may be shown on the display and control unit 18 together with a request to said persons to identify themselves.

Alternatively or additionally pictures of non-identified persons may be displayed outside the elevator car 6, e.g. in a security center 30, in order to allow security personal to resolve the issue.

An elevator system 2 according to exemplary embodiments of the invention allows a person to leave the lobby and to enter one of the floors of a building only after having been identified as being allowed to enter the building and the respective floor.

A number of optional features are set out in the following. These features may be realized in particular embodiments, alone or in combination with any of the other features.

In an embodiment, the second camera may be configured to take the at least one second picture from a height above the persons residing within the elevator car in a basically downward direction. The second camera in particular may be configured to take the at least one second picture in a vertical or close to vertical downward direction. Such a configuration is very suitable for counting the number of persons residing within the elevator car and reliably prevents person from hiding and not being detected within the picture captured by the at least one second camera.

In an embodiment, the second camera may be configured to be arranged at the ceiling of the elevator car for allowing to take the at least one second picture from a height above the heads of the persons residing within the elevator car in a vertical downward direction.

In an embodiment, the field of view of the first camera may be oriented in a basically horizontal direction. The first camera in particular may be arranged at a height of 1.5 m to 2.5 m, in particular at a height between 1.75 m and 2.0 m above the bottom of the elevator car. The first camera in particular may be configured to be arranged at a wall, in particular at the rear wall, of the elevator car. Such a configuration is very suitable for capturing pictures allowing for the identification of individual persons, in particular by face recognition.

In an embodiment the elevator access control system further may comprise an evaluation unit which is configured for identifying persons from the at least one first picture captured by the first camera, counting the number of persons residing within the elevator car from the at least one second picture captured by the second camera and providing a car enable signal only in case the number of identified persons is identical to the number of persons which have been identified from the at least one first picture. This provides a very effective access control.

In case the number of identified persons is not identical to the number of persons which have been identified from the at least one first picture all persons within the elevator car, all persons may be requested to leave the elevator car in order to start over again from an empty elevator car. This allows to solve the issue of an unidentified person being present within the elevator car without the need for intervention by security personal.

In an alternative embodiment the elevator access control system may be configured for tracking all persons entering the elevator car in the second picture(s) allowing to distinguish between authorized and unauthorized person(s) within the second picture(s). In such an embodiment the elevator car may be allowed to move as soon as all unauthorized persons have left the elevator car.

This allows the elevator car to depart faster and more conveniently as it does not require all persons to leave the elevator car.

Exemplary embodiments of the invention further may include an elevator car which is equipped with an elevator access control system according to an exemplary embodiment of the invention as it has been described before. Such an elevator car allows to check whether all persons residing within the elevator car have been identified as being allowed to enter the building and to prevent any further movement of the elevator car as long as not all persons residing within the elevator car have been identified.

In an embodiment the elevator car may further comprise at least one lighting device, which is configured for illuminating the persons residing within the elevator car. The at least one lighting device in particular may be configured for illuminating the faces of the persons residing within the elevator car. Providing an appropriate illumination improves the quality and reliability of the identification.

Exemplary embodiments of the invention may further include an elevator system which comprises such an elevator car and further an elevator control unit which is configured for allowing the elevator car to depart only if all persons residing within the elevator car have been identified as being allowed to use the elevator system.

In an embodiment the elevator system may comprise a database including a set of data for each person being allowed to use the elevator system. Such a database allows an easy identification of the person which are allowed to enter the building via the elevator system.

In an embodiment the database may comprise biometric data, in particular facial data, of persons which are allowed to use the elevator system. In consequence, these persons may be identified by their biometric data.

In an embodiment the elevator system the database may comprise optical code data, in particular QR code data, related to persons which are allowed to use the elevator system. Storing optical code data, in particular QR code data, in the database provides an additional way of providing access to the building. It in particular allows persons such as occasional visitors, for which biometric data is not available, to enter the building.

In an embodiment the database may comprise a list of allowed destinations for each persons allowed to use the elevator system and the elevator control unit is configured to allow the elevator car to stop only at destinations which are included in the list of allowed destinations of at least one of the persons which have been identified from the at least one first picture as currently residing within the elevator car. This helps to prevent persons from unauthorized access to floors they are not allowed to enter.

In an embodiment the elevator access control system in particular may be configured for tracking all persons entering the elevator car in the second picture(s) and associating a list of allowed landings with every tracked person which has been identified. The elevator access control system may further be configured for issuing an alarm signal in case a tracked person leaves the elevator car at a landing he/she is not allowed to enter. This reliably prevents persons from unauthorized access to floors they are not allowed to enter.

In an embodiment the database may comprise a desired destination for at least one of the persons allowed to use the elevator system and the elevator control unit is configured for moving to the desired destinations of all persons which have been identified from the at least one first picture as currently residing within the elevator car. This facilitates the use of the elevator system as the elevator car automatically moves to the desired destinations of all persons residing within the elevator car without human intervention, i.e. the users do not need to manually enter service calls for selecting the desired destinations.

In an embodiment the method of controlling access to an elevator system may comprise the steps of identifying a list of allowed destinations for each person identified from the first picture and allowing the elevator car to stop only at destinations which are included in the list of allowed destination of at least one person identified from the first picture. Thus, access to each floor may be controlled individually, and persons which are allowed to access only some of the floors of the building are prevented from entering floors they are not allowed to enter.

In an embodiment the method further may include the steps of identifying a destination assigned to at least one of the persons which has been identified from the at least one first picture as residing within the elevator car and moving the elevator car to said destination. In such a configuration the person does not need to enter his desired destination manually; as a result, the usage of the elevator system is facilitated and more convenient.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention not be limited to the particular embodiment disclosed, but that the invention include all embodiments falling within the scope of the claims.

### REFERENCES

2 elevator system
3 tension member
4 hoistway
5 drive
6 elevator car
7 rear wall of the elevator car
8 landing
9 ceiling of the elevator car
10 hoistway door
11 floor of the elevator car
12 elevator car door
14 first camera
16 second camera
18 display and control unit
20 lighting device
22 signal line
24 evaluation unit
26 elevator control unit
28 database
30 security center

1. Elevator access control system comprising at least two cameras (14, 16) including:
a first camera (14) which is configured to be mounted to an elevator car (6) for capturing at least one first picture of persons residing within the elevator car (6), the at least one first picture allowing to identify individual persons;
a second camera (16) which is configured to be mounted to the elevator car (6) for capturing at least one second picture of persons residing within the elevator car (6), the at least one second picture allowing to count the number of persons residing within the elevator car (6).

2. Elevator access control system according to claim 1, wherein the second camera (16) is configured to take the at least one second picture from a height above the persons in a basically downward direction (V₂).

3. Elevator access control system according to claim 2, wherein the second camera (16) is configured to be arranged at the ceiling (9) of the elevator car (6).

4. Elevator access control system according to claim 1, wherein the field of view of the first camera (14) is oriented in a basically horizontal direction (V₁).

5. Elevator access control system according to claim 1, wherein the first camera (14) is configured to be arranged at a wall, in particular at the rear wall (7), of the elevator car (6).

6. Elevator access control system according to claim 1 further comprising an evaluation unit (24) which is configured for identifying persons from the at least one first picture captured by the first camera (14), counting the number of persons residing within the elevator car (6) from the at least one second picture captured by the second camera (16) and providing a car enable signal only in case the number of identified persons is identical to the number of persons residing within the elevator car (6).

7. Elevator car (6) equipped with the elevator access control system according to claim 1.

8. Elevator car (6) according to claim 7 further comprising at least one lighting device (20) configured for illuminating the persons residing within the elevator car (6), wherein the at least one lighting device (20) in particular is configured for illuminating the faces of persons residing within the elevator car (6).

9. Elevator system (2) comprising an elevator car (6) according to claim 7 further comprising an elevator control unit (26) which is configured for allowing the elevator car (6) to move only in case the number of persons which have been identified from the at least one first picture is identical to the number of persons which have been counted from the at least one second picture.

10. Elevator system (2) according to claim 9, comprising a database (28) including a set of data for each person which is allowed to use the elevator system (2).

11. Elevator system (2) according to claim 10, wherein the database comprises biometric data, in particular facial data, of persons which are allowed to use the elevator system (2), and/or wherein the database (28) comprises optical code data, in particular QR code data, related to persons which are allowed to use the elevator system (2).

12. Elevator system (2) according to claim 10, wherein the database (28) comprises for each person allowed to use the elevator system (2) a list of allowed destinations and wherein the elevator control unit (26) is configured for allowing the elevator car (6) to stop only at destinations which are included in the list of allowed destinations of at least one of the persons which have been identified from the at least one first picture.

13. Elevator system (2) according to claim 10, wherein the database (28) comprises a desired destination for at least one of the persons allowed to use the elevator system (2) and wherein the elevator control unit (26) is configured for moving to the desired destinations of all persons which have been identified from the at least one first picture.

14. Method of controlling access to an elevator system (2) comprising at least one elevator car (6), wherein the method comprises the steps of:
using a first camera (14) for capturing at least one first picture of persons residing within the elevator car (6);
identifying individual persons from the at least one first picture captured by the first camera (14);
using a second camera (16) for capturing at least one second picture of persons residing within the elevator car (6);
counting the number of persons residing within the elevator car (6) from the at least one second picture captured by the second camera (16);
comparing the number of persons identified from the at least one first picture with the number of persons residing within the elevator car (6) counted from the at least one second picture; and
allowing the elevator car (6) to move only in case the number of persons identified from the at least one first picture is equal to the number of persons counted from the at least one second picture.

15. Method of controlling access to an elevator system (2) according to claim 13, wherein the method comprises
identifying a list of allowed destinations for each person identified from the first picture; and
allowing the elevator car (6) to stop only at destinations which are included in the list of allowed destinations of at least one person identified from the first picture.
